(19) United States
(12) Patent Application Publication
(10) Pub. No.: US 2003/0151666 A1
(43) Pub. Date: Aug. 14, 2003

(54) Imaging apparatus with mouse pad

(76) Inventor: Modest Khovaylo, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 10/075,667

(22) Filed: Feb. 13, 2002

(51) Int. Cl. H04N 5/225

(52) U.S. Cl. 348/207.1

(57) ABSTRACT

An imaging apparatus comprising a mouse pad.

### BACKGROUND OF THE INVENTION

Computer work areas typically include a computer with an attached monitor and keyboard. Most computer work areas also include a computer mouse which may be displaced by a user to manipulate text or other information displayed on the computer monitor. The work area usually includes a mouse pad. A mouse pad is a pad, typically about the size of a pad of paper, which has a flat top surface designed to co-act with a computer mouse. A conventional computer mouse has a roller ball which rolls over the surface of the mouse pad to generate electrical signals used in positioning a cursor device displayed on the computer monitor. An optical mouse images the surface of a mouse pad and processes the images created to generate cursor positioning signals. Mouse pads are adapted to co-act with the particular type of mouse to be used. Examples of mouse pads are disclosed in the following U.S. Patents which are hereby incorporated by reference for all that is disclosed therein: U.S. Pat. No. 6,143,295, issued Nov. 7, 2000 of Perry; U.S. Pat. No. 5,696,536, issued Dec. 9, 1997 of Murphy; and U.S. Pat. No. 4,834,502, issued May 30, 1989 of Bristol et al.

Many computer work areas also include imaging devices such as optical scanners, which generate digital data used to produce computer manipulatable images of objects such as documents, photographs, etc. Currently flat bed optical scanners are the most commonly used imaging devices. However recently so-called “look-down” imagers are also appearing more frequently on desk tops. A look-down imager has a stationary imaging assembly, such as a digital camera, suspended above an imaging area. The digital camera used is sometimes a conventional hand-held type digital camera mounted on a tripod or the like. The digital camera is also sometimes the type having an offset illumination assembly and other features specifically adapted for document imaging and which is part of an integrated unit including a support stand with control surfaces. With the above-described devices, and others such as telephones, printers and other computer peripherals competing for space on the desktop, lack of work space is becoming a problem for computer users.

### SUMMARY OF THE INVENTION

The invention in one embodiment may comprise an imaging apparatus including a mouse pad.

In another embodiment of the invention, a work assembly comprises a computer and an optical imaging apparatus operably connected to the computer and having an object-to-be-imaged locator comprising a mouse pad.

In another embodiment the invention may comprise a computer mouse pad having indicia for aligning an object to be imaged with an imaging apparatus.

In another embodiment of the invention, an imaging apparatus comprises means for supporting an object to be imaged and means for co-acting with a computer mouse, wherein the means for supporting comprises the means for co-acting.

The invention in another embodiment may comprise a work assembly including a computer having a computer mouse operably connected thereto, means for imaging an object, and means for positioning the object relative to the imaging means and for co-acting with the mouse.

In another embodiment of the invention a method of data acquisition and processing comprises placing a mouse pad in registration with the field of view of an imaging device; placing an object on the mouse pad and imaging the object on the mouse pad.

In yet another embodiment of the invention, a method of saving space on a desk top supporting a computer with a computer mouse and an overhead imaging device comprises providing a mouse pad adapted to co-act with the mouse and using the mouse pad as an object locator for the overhead imaging device.

### BRIEF DESCRIPTION OF THE DRAWINGS

Exemplary embodiments of the invention, including the best mode presently contemplated, are illustrated in the attached drawing in which:

FIG. 1 is a perspective view of a desk work top surface which includes a computer assembly view and an imaging apparatus;

FIG. 2 is a perspective of the desk top of FIG. 1 with a mouse pad positioned in an imaging apparatus image window;

FIG. 3 is a perspective view of a desk top as in FIG. 2 but with an alternative imaging apparatus and mouse pad.

FIG. 4 is a top view of a portion of a desk top illustrating another embodiment of an imaging apparatus and mouse pad.

### DETAILED DESCRIPTION

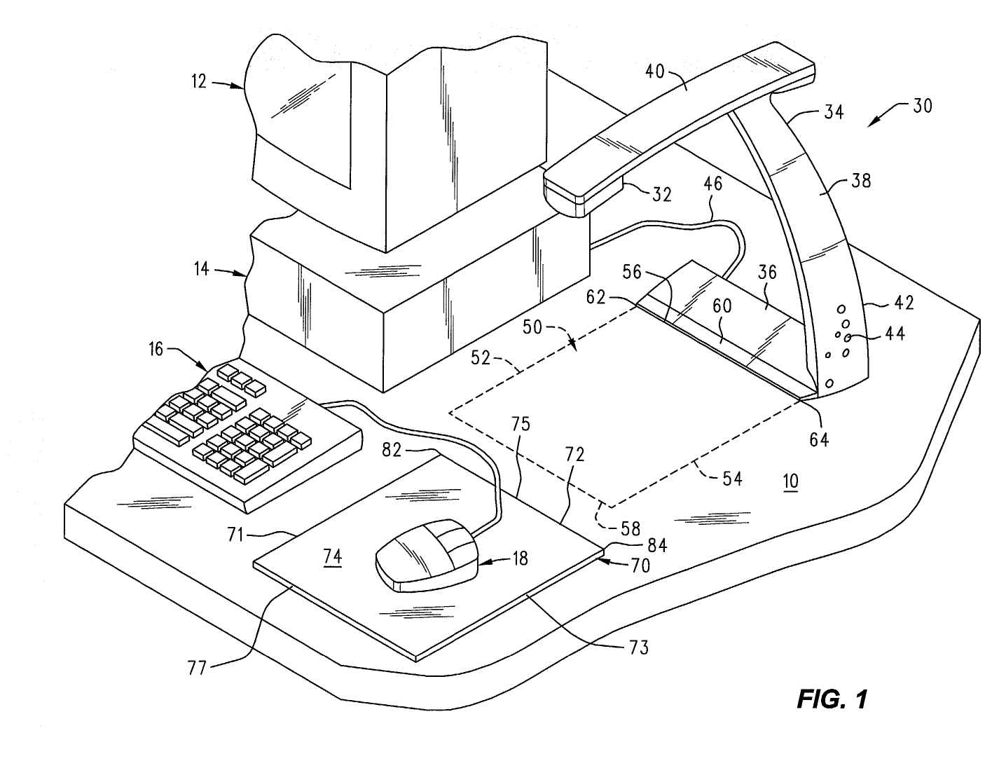

FIG. 1 shows a desk top work surface 10 which supports a computer 12 having a monitor 14, keyboard 16, and mouse 18. The desk top work surface 10 also supports a look-down type imaging apparatus 30 having an optical/electronic assembly supported by a stand 34. The optical/electronic assembly may be a camera such as a digital camera 32 which is adapted for document imaging.

The stand 34 may include a base 36, a vertically-extending riser 38 and a horizontally-extending arm 40. A plurality of control surfaces 42, 44 etc. may be mounted on the stand for enabling actuation, focusing and/or other functions of the imaging apparatus 30. The imaging apparatus may be operably connected to computer 12 as by a connector cable 46 or through other connecting means such as infrared data transfer connections or other wireless connections. The imaging apparatus 30 has a “field of view” including an “image window” 50 on the desk top (shown in dashed lines) which delineates the bounds of the image of an object that will be captured by the imaging apparatus. The image window 50 is an area on the desk top 10 determined by the position and orientation of camera 32 and represents the area that would be imaged on a flat object like a sheet of paper. The image window 50 may have a rectangular shape including longitudinal edge portions 52, 54 and lateral edge portions 56, 58 or it may have another shape, e.g., oval. The base 36 may have a front lip portion 60 which, in this embodiment, is aligned with image window lateral edge 36. The front lip may include pad alignment indicia 62, 64, which in the illustrated embodiment comprise terminal end points of front lip 60.

A mouse pad 70 lies on the desk top 10. The mouse pad 70 may include a periphery 72 with edge portions 71, 73, 75, 77 corresponding in size and shape to image window 50. The pad 70 has a flat top surface 74 adapted to co-act with mouse 18. The mouse pad may be provided with a non-slip bottom surface and in this embodiment is adapted to be freely-moveable to different locations on the desk top 10. Because the periphery of the mouse pad 70 in this embodiment corresponds to the image window 50, the mouse pad may be placed with the corners of either of the lateral edges 75, 77 e.g. corners 82, 84 in registration with lip 60 end points 62, 64. When the mouse is thus positioned, surface 74 thereof defines an object-to-be-imaged support surface.

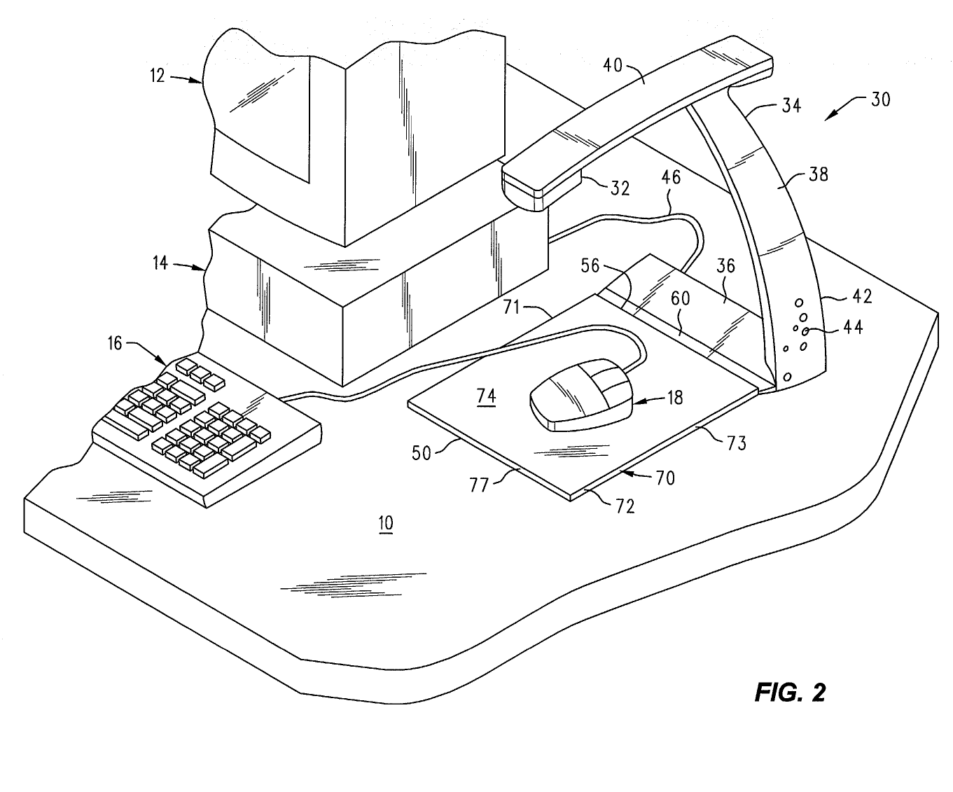

FIG. 2 illustrates the mouse pad 70 positioned with its peripheral edge portions 71, 73, 75, 77 aligned with the imaging window 50. Thus a document which is to be imaged may be placed on the mouse pad and the borders of the image that will be produced will correspond to the periphery 72 of the mouse pad. The mouse 18 may be operated on the mouse pad 70, as shown in FIG. 2, when a document or other object to be imaged is not positioned thereon.

It will be appreciated by those having skill in the art that the actual three-dimensional field of view of camera 32, when the image window 50 on the desk top is rectangular, will be generally pyramid-shaped, tapering upwardly and inwardly from a pyramid base (the image window) on the desk top to the camera aperture. Thus, if a mouse pad were extremely thick (high) its top surface should be slightly smaller than the image window 50 on the desk top in order to exactly conform to the pyramid-shaped field of view at the particular elevation above the desk top of the mouse pad top surface. However, for most mouse pads, which are relatively thin, little or no adjustment in size compared to the image window size would be required. Accordingly, when a mouse pad or indicia on a mouse pad are referred to herein “as having the same size as the image window” or as “corresponding to the image window” it is to be understood as meaning being sufficiently close in size to perform the function of object-alignment with the imaging apparatus, whether or not the periphery of the mouse pad is located exactly at the “surface” of the camera field-of-view pyramid.

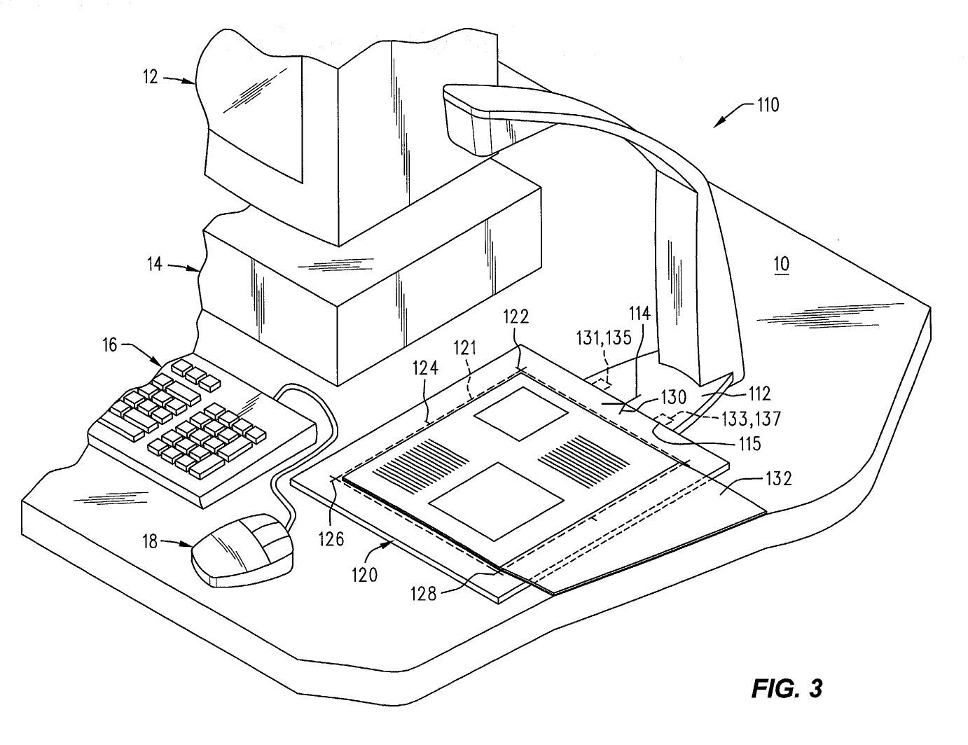

FIG. 3 illustrates the desk top of FIG. 2 with an alternative imaging apparatus 110 and alternative mouse pad 120. In this embodiment the imaging apparatus has a base 112 smaller than the lateral dimensions of an image window 121. The base 112 may include pad alignment indicia 114, such as a single mark at the center of the base. The base 112 may have a straight front edge portion 115 which also facilitates alignment of the mouse pad 120 with the imaging apparatus 110. The mouse pad 120 in this embodiment is larger laterally and longitudinally than the image window 121 but includes indicia 122, 124, 126, 128 etc. which correspond in location to the image window 121 when the pad 120 is properly aligned with the imaging apparatus 112 as shown in FIG. 3. The positioning of the mouse pad 120 with respect to the imaging apparatus base 112 may be facilitated by a pad positioning indicia 130 which in the illustrated embodiment has an inverted “v” shape and which is adapted to be positioned opposite the alignment indicia 114 on base 112. (As used herein the term “indicia” is to be understood as being both singular and plural, i.e., “indicia” as used herein means indicium as well as indica, and refers to anything used as an indicator such as a mark, an edge surface, etc.)

FIG. 3 illustrates an object to be imaged such as a magazine 132. The magazine is positioned for imaging on the mouse pad 120. The portion of the magazine that is imaged will be that portion located within image window 121.

In the embodiment illustrated in FIG. 3, as an alternative to alignment indicia 114, 130, locator tabs 131, 133 could be provided on the mouse pad 120. These tabs are received in corresponding slots 135, 137 in the imaging apparatus base 112. The slots closely slidingly receive the tabs therein and hold the tabs in tight frictional engagement with the base to prevent displacement of the mouse pad 120 from proper alignment with the imaging apparatus 110. It is to be understood that any number of such holding devices could be used such as clamping devices, interlocking flanges, hook-and-loop-type fasteners or any other type of holding device.

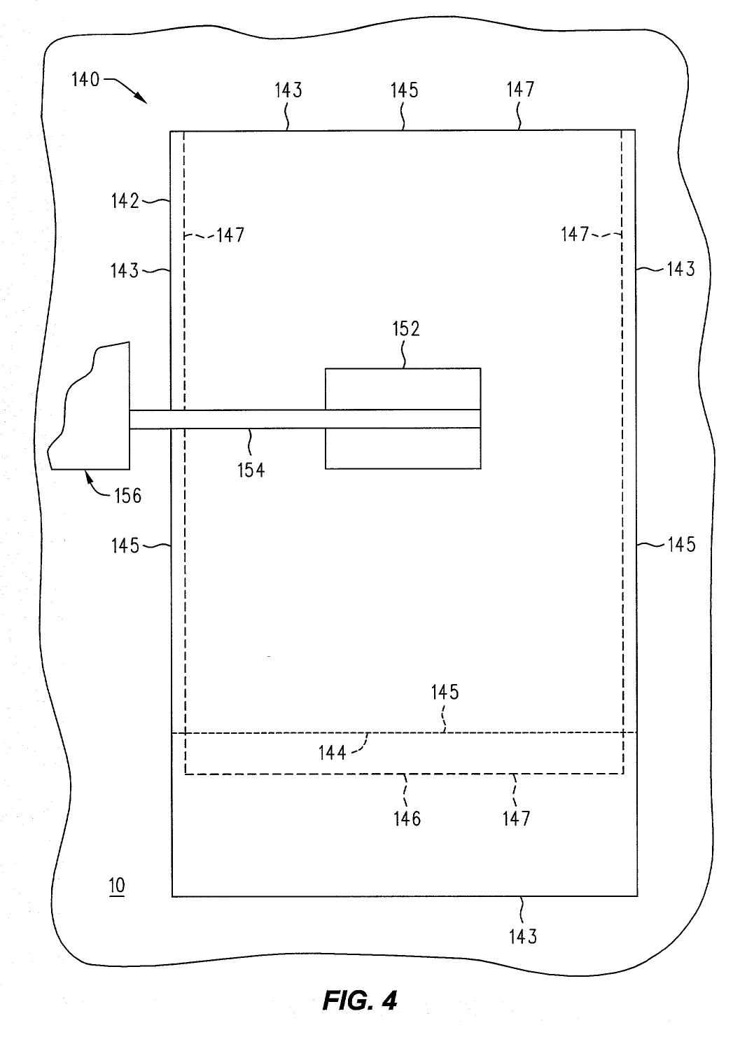

In some embodiments an imaging apparatus may have more than one image window which may be selected by the user depending upon the size of document which is to be imaged. In such an embodiment multiple sets of indicia may be provided on the mouse pad to correspond with the different size image windows. For example, FIG. 4 shows a mouse pad 140 with legal-size, letter-size and A4-size locating indicia 143, 145, 147 which correspond with legal-size, letter-size and A4-size image windows 142, 144, 146 of an associated imaging device 156. As shown in FIG. 4 the indicia associated with the first window may be the peripheral edge of the mouse pad 140 and the indicia associated with second and third windows may include combinations of mouse pad peripheral portions and surface graphics in the form of dashed lines.

FIG. 4 also illustrates another embodiment of an imaging apparatus. In this embodiment the imaging apparatus 150 is a digital camera 152 mounted on a horizontal support arm 154 which is attached to a vertical support structure such as a computer monitor 156. In this embodiment no portion of the imaging apparatus support structure is located on the desk work surface 10. In this embodiment the mouse pad 140 periphery 142 may be aligned with the camera image window 143 by use of the computer monitor. An image of the desk top 10 and the window 143 is displayed on the computer monitor. The display on the monitor is produced by an input signal from digital camera 152 which images the portion of the desk top 10 corresponding to image window 143. The mouse pad 140 is moved into proper position by a user who, after placing the mouse pad below camera 152, observes the pad's position on the computer monitor and then moves the pad 140 into registration with the image window 143.

The digital camera, rather than being a camera specifically adapted for document imaging and having multiple image windows could, in another embodiment, be a hand-held type digital camera having a single field of view that is mounted on a support arm 154.

What is claimed is:

1. An imaging apparatus comprising a mouse pad.

2. The imaging apparatus of claim 1 wherein said mouse pad comprises an object-to-be-imaged support surface.

3. The imaging apparatus of claim 1 wherein said imaging apparatus further comprises a camera positioned in spaced-apart relationship with said mouse pad.

4. The imaging apparatus of claim 3 wherein said camera comprises a digital camera.

5. The imaging apparatus of claim 2 wherein said camera has an image window and wherein said mouse pad is at least coextensive with said image window.

6. The imaging apparatus of claim 1 wherein said mouse pad comprises object-to-be-imaged positioning indicia.

7. The imaging apparatus of claim 6 wherein said object-to-be-imaged positioning indicia comprises graphics.

8. The imaging apparatus of claim 6 wherein said object-to-be-imaged positioning indicia comprises at least one peripheral edge portion of said mouse pad.

9. The imaging apparatus of claim 6 wherein said positioning indicia correspond to an image window of a camera.

10. The imaging apparatus of claim 1 wherein said mouse pad is physically attached to a base portion of said imaging apparatus.

11. A work assembly comprising:
a computer; and
an optical imaging apparatus operably connected to said computer and having an object-to-be-imaged locator comprising a mouse pad.

12. A computer mouse pad comprising indicia for aligning an object to be imaged with an imaging apparatus.

13. The mouse pad of claim 12 wherein said indicia comprise graphical indicia.

14. The mouse pad of claim 12 wherein said indicia comprise at least one peripheral edge portion of said mouse pad.

15. The mouse pad of claim 12 wherein said indicia correspond to an image window of said imaging apparatus.

16. An imaging apparatus comprising:
means for supporting an object to be imaged;
means for co-acting with a computer mouse;
wherein said means for supporting comprises said means for co-acting.

17. A work assembly comprising:
means for computing having a computer mouse operably connected thereto;
means for imaging an object; and
means for positioning said object relative to said imaging means and for co-acting with said mouse.

18. A method of data acquisition and processing comprising:
placing a mouse pad in registration with the field of view of an imaging device;
placing an object on the mouse pad; and
imaging the object on the mouse pad.

19. The method of claim 18 further comprising:
operating a computer mouse on the mouse pad.

20. The method of claim 19 wherein operating a computer mouse on the mouse pad comprises operating the mouse with the mouse pad in registration with the field of view of the imaging device.

21. The method of claim 19 wherein operating a computer mouse on the mouse pad comprises operating the mouse with the mouse pad removed from registration with the field of view of the imaging pad removed from registration with the field of view of the imaging device.

22. A method of saving space on a desk top supporting a computer with a computer mouse and an overhead imaging device comprising:
providing a mouse pad adapted to co-act with the mouse; and
using the mouse pad as an object locator for the overhead imaging device.
